(19) United States
(12) Patent Application Publication
(10) Pub. No.: US 2005/0247697 A1
(43) Pub. Date: Nov. 10, 2005

(54) Warning assembly for reminding people of using times counted of edible oil in a deep fryer

(76) Inventor: Chang Li-Chen Wu, Pa-Te City (TW)

Correspondence Address: SUPREME PATENT SERVICES, POST OFFICE BOX 2339, SARATOGA, CA, 95070, US

(21) Appl. No.: 10/839,565

(22) Filed: May 4, 2004

(51) Int. Cl. H05B 1/02

(52) U.S. Cl. 219/506; 219/438

(57) ABSTRACT

Disclosed is a warning assembly for reminding people of using times counted of edible oil in a deep fryer, in which a thermal switch is electrically connected to a display and a buzzer. The thermal switch will sense the temperature change of an inner pot and take a reciprocal travel of the change thereof as a cycle, and it will actuate the buzzer to buzz for reminding a user of replacing the edible oil inside the deep fryer when the accumulated times of cycle reaches a predetermined number.

### BACKGROUND OF THE INVENTION

1. Field of the Invention

The present invention relates to a warning device, and particularly to a warning assembly for reminding people of using times counted of edible oil in a deep fryer, in which a thermal-control switch is electrically connected with a display device and a buzzer for recording and buzzing.

2. The Prior Arts

A conventional deep fryer is usually comprised of an inner pot as well as a housing. The inner pot is placed inside the housing. A control switch is attached externally to the housing. To use the deep fryer, edible oil is first poured into the inner pot, and the control switch is applied to ignite and the edible oil is heated to a proper temperature. Food is then put into the inner pot and fried until it is ready for service. The food is then dredged out and the control switch is closed down to complete the frying operation.

Since the conventional deep fryer is usually not provided with a warning device for reminding a user of replacing the edible oil after it has been used as many times as predetermined, the edible oil is occasionally overused to create unexpected poisonous substances, harmful to people's health.

### SUMMARY OF THE INVENTION

The primary object of the present invention is to provide a warning assembly for reminding people of using times counted of edible oil in a deep fryer by adding a thermal switch to an inner pot of the deep fryer for recording temperature-change cycles, and actuating buzzing when the accumulated times of cycle reaches a predetermined number.

In order to realize above object, a thermal switch is electrically connected to a display and a buzzer. The thermal switch will sense the temperature change of the inner pot and take a reciprocal travel of the change thereof as a cycle, and it will actuate the buzzer to buzz for reminding a user of replacing the edible oil inside the deep fryer when the accumulated times of cycle reaches a predetermined number.

The merits of the present invention is that since the thermal switch that is capable of sensing temperature in the range from the room temperature to 110±50° C. for example, is disposed somewhere outside the inner pot of the deep fryer, on a bottom or lateral surface, for reminding a user of replacing the edible oil in the deep fryer when a predetermined number of times of use is reached, 15 times for instance. Thus, the quality of the edible oil can be ensured to thereby avoid doing any harm to people's health.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is an exploded view showing inside structure of the present invention;

FIG. 2 is an assembled sectional view of the inside structure of the present invention; and

FIG. 3 shows a side elevational view of the present invention.

### DETAILED DESCRIPTION OF THE PREFERRED EMBODIMENT

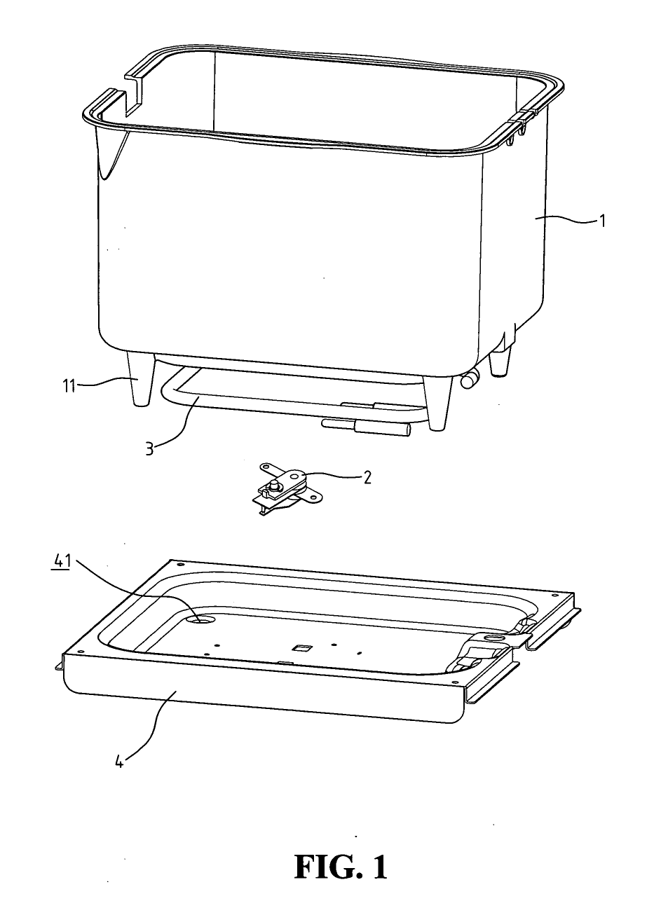

FIGS. 1-3 show an exploded view, an assembled sectional view and side elevational view of inside structure of the present invention, respectively.

A warning assembly for reminding people of using times counted of edible oil in a deep fryer is comprised of an inner pot 1, a thermal switch 2, a heating pipe 3, a heat-insulating pan 4, and a housing 5.

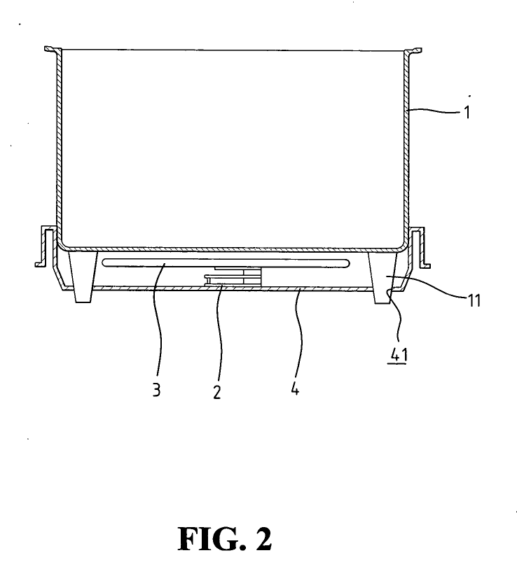

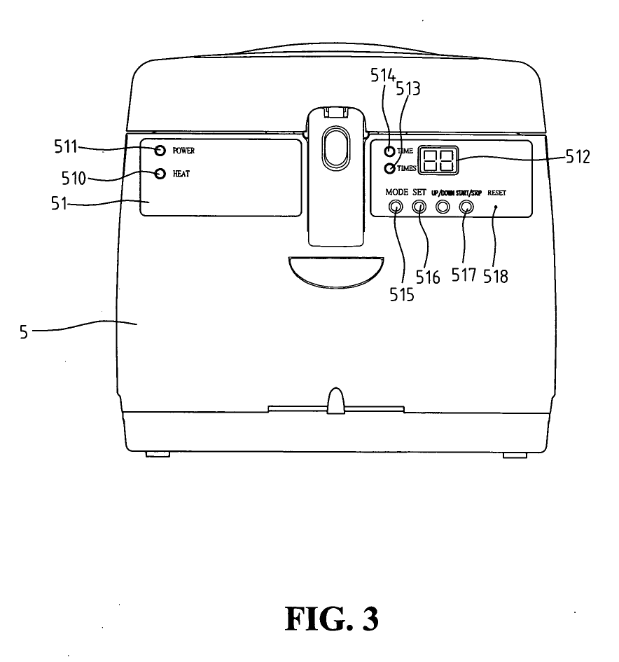

As illustrated in FIGS. 1 and 2, the inner pot 1, with the exception of a foot portion 11 formed on the bottom surface thereof, coincides substantially with the housing 5 in shape. The thermal switch 2, which functions to record temperature change, from room temperature to 110±50° C., for example, is disposed at a central position of the bottom surface of the inner pot 1. The heating pipe 3 is attached and extended peripherally on the bottom surface of the inner pot 1. The heat-insulating pan 4, which resembles the inner pot 1 in shape and is arranged to mate with the thermal switch 2 and the heating pipe 3, has a through hole 41 in each corner for the foot portion 11 to get inserted therein. The heat-insulating pan 4 also has two ends thereof checked at two sides of the bottom surface of the inner pot 1 to combine with the latter for heat insulation. Referring to FIG. 3, a deep fryer with warning assembly of the present invention is completed by putting the inner pot 1, thermal switch 2, heating pipe 3, and heat-insulating pan 4 together, then placing the unitary body in the housing 5.

Referring to FIG. 3 again and also FIGS. 1 and 2, a user is supposed to operate a display device 51 on the housing 5. The display device 51 is divided into two sections, in which one section is provided with a “HEAT” light 510 and a “POWER” light 511 to show the working conditions and ON/OFF operation of the power supply; and the other section is provided with a display 512 on an upper portion and a “TIMES” or a “TIME” indicator 513, 514 located aside.

After power is supplied to the deep fryer, a user is requested to depress first a Start/Stop key 517 under the display 512 to lighten the “HEAT” light 510, then a Mode switching key 515 to selectively lighten the “TIME” indicator 514 or the “TIMES” indicator 513 to show the operation mode of the deep fryer.

In the case of time setting, the user is now supposed to depress a “SET” button 516 to start operation of the display 512, and depress a “RESET” button 518 for resetting the system.

After the deep fryer starts to work, the thermal switch 2 will sense the temperature change from the room temperature to 110±50° C. as one cycle and show it on the display 51, and at the moment when the accumulated times of cycle reaches a predetermined number, it will notify a buzzer (not shown) to buzz to remind the user of replacing the edible oil inside the deep fryer to thus avoid doing any harm to people's health.

In the above described, at least one preferred embodiment has been described in detail with reference to the drawings annexed, and it is apparent that numerous changes or modifications may be made without departing from the true spirit and scope thereof, as set forth in the claims below.

1. A warning assembly for reminding people of using times counted of edible oil in a deep fryer, in which a thermal switch which is electrically connected to a display and a buzzer is provided to an inner pot.

2. The warning assembly as claimed in claim 1, wherein the thermal switch senses and takes a reciprocal travel of temperature change of the inner pot as a cycle, and show the accumulated times of cycle on the display and actuate the buzzer to buzz when a predetermined times of cycle is reached.

3. The warning assembly as claimed in claim 1, wherein a heating pipe is extendedly attached on the bottom surface of the inner pot peripherally.

4. The warning assembly as claimed in claim 1, wherein the predetermined times is 15 times.

5. The warning assembly as claimed in claim 1, wherein the temperature change is ranged from the room temperature to 110±50° C.

6. The warning assembly as claimed in claim 1, wherein the thermal switch is mounted on the inner pot.
